(19) United States
(12) Patent Application Publication
(10) Pub. No.: US 2025/0381484 A1
(43) Pub. Date: Dec. 18, 2025

(54) INFORMATION PROCESSING DEVICE AND RECORDING MEDIUM

(71) Applicant: SEGA CORPORATION, Tokyo (JP)

(72) Inventors: Keisho Ichikawa, Tokyo (JP); Tomoki Iwasaki, Tokyo (JP); Kota Miura, Tokyo (JP)

(73) Assignee: SEGA CORPORATION, Tokyo (JP)

(21) Appl. No.: 19/314,532

(22) Filed: Aug. 29, 2025

Related U.S. Application Data
(63) Continuation of application No. PCT/JP2024/000711, filed on Jan. 12, 2024.

(30) Foreign Application Priority Data
Mar. 2, 2023 (JP) 2023-032237

(51) Int. Cl. A63F 13/69; A63F 13/79; A63F 13/90

(52) U.S. Cl. CPC A63F 13/69; A63F 13/79; A63F 13/90

(57) ABSTRACT

An information processing device includes a hardware processor that: extracts, from among game contents owned by a player, a predetermined number of game contents in descending order of predetermined parameters of the extracted game contents, identifies, as a reference game content among the extracted game contents, a game content having a lowest predetermined parameter among the predetermined parameters, sets, as set game contents, some or all of the owned game contents that have not been extracted, and matches a predetermined parameter of each of the set game contents with the lowest predetermined parameter of the reference game content. In response to the player acquiring a cost for increasing a predetermined parameter of a growing game content, with the reference game content as the growing game content, the hardware processor automatically consumes the cost and increases the predetermined parameter of the growing game content.

### CROSS-REFERENCE OF RELATED APPLICATIONS

The present application claims the benefit of priority from JP 2023-032237 filed on Mar. 2, 2023, the entire disclosures of which are incorporated herein by reference.

### BACKGROUND

### Technical Field

The present invention relates to an information processing device and a recording medium storing instructions.

### Description of Related Art

Conventionally, games have been known in which a player grows or trains some contents (for example, a character, an item, or the like) that the player owns. This growing may involve, for example, increasing a predetermined parameter (for example, a level) of the contents (owned contents) owned by the player.

In this regard, patent document 1 discloses art for collectively combining groups of owned contents that are of the same type, thereby reducing the effort required of the player in growing the owned contents.

### PATENT DOCUMENTS

Patent Document 1: JP 6891987

### Technological Problem to Be Solved by Invention

In such games, in order to reduce the effort required to grow contents, it is conceivable to set a content having a predetermined parameter of a prespecified ranking (for example, third) as a reference content among the owned contents having predetermined parameters, and to match the predetermined parameters of other contents (set contents) with the predetermined parameter (reference parameter) of the reference content. Meanwhile, the ranking varies among the predetermined parameters of the owned contents depending on game play. Thus, when a player wanted to increase the predetermined parameter of the reference content, after confirming which of the owned contents should be the reference content, the player had to search for such reference content from a list of the owned content and designate the reference content as a growing content to be grown by the player. Thus, conventional gaming systems do not provide any algorithm to automatically update a growth reference of game contents in accordance with variation of parameters of the game contents in real time.

### SUMMARY

One or more embodiments of the present invention provide an information processing device and a recording medium storing instructions that provide a specific algorithm to automatically update a growth reference of game contents in accordance with variation of parameters of the game contents in real time. This provides a practical, technological improvement over conventional gaming systems that would be readily appreciated by those skilled in the art. As a result, for example, it becomes possible to reduce the time and effort required to grow a game content, especially a reference game content, among game contents owned by a player even when a ranking of game contents varies during game play.

According to a first aspect of the present invention, an information processing device causes a terminal device to execute a growing game, and comprises a hardware processor that: extracts, from among game contents owned by a player, a predetermined number of game contents in descending order of predetermined parameters of the extracted game contents, identifies, as a reference game content among the extracted game contents, a game content having a lowest predetermined parameter among the predetermined parameters, sets, as set game contents, some or all of the owned game contents that have not been extracted, and matches a predetermined parameter of each of the set game contents with the lowest predetermined parameter of the reference game content, wherein in response to the player acquiring a cost for increasing a predetermined parameter of a growing game content to be grown by the player, with the reference game content as the growing game content, the hardware processor automatically consumes the cost and increases the predetermined parameter of the growing game content.

Furthermore, in a second aspect of the present invention, the hardware processor changes the growing game content to another game content every time the reference game content is changed to the other game content.

Moreover, in a third aspect of the present invention, the hardware processor automatically consumes the cost until the predetermined parameter of the growing game content reaches a predetermined value.

Furthermore, in a fourth aspect of the present invention, the predetermined value is a value specified by the player.

In addition, in a fifth aspect of the present invention, the predetermined value is a recommended value of a predetermined parameter corresponding to a predetermined quest.

Furthermore, in a sixth aspect of the present invention, the hardware processor does not consume the cost when matching a predetermined parameter of each of the set game contents with the lowest predetermined parameter of the reference game content.

Moreover, according to a seventh aspect of the present invention, an information processing device causes a terminal device to execute a growing game, and comprises hardware processor that: extracts, from among game contents owned by a player, a predetermined number of game contents in descending order of predetermined parameters of the extracted game contents, identifies, as a reference game content among the extracted game contents, a game content having a lowest predetermined parameter among the predetermined parameters, sets, as set game contents, some or all of the owned game content that have not been extracted, and matches a predetermined parameter of each of the set game contents with the lowest predetermined parameter of the reference game content, wherein in response to the player acquiring a cost for increasing a predetermined parameter of a growing game content to be grown by the player, with the reference game content as the growing game content, the hardware processor asks the player whether to consume the cost and increase the predetermined parameter of the growing game content.

According to the eighth aspect of the present invention, a non-transitory computer readable recording medium storing instructions that cause an information processing device causing a terminal device to execute a growing game to execute: extracting, from among game contents owned by a player, a predetermined number of game contents in descending order of predetermined parameters of the extracted game contents, identifying, as a reference game content among the extracted game contents, a game content having a lowest predetermined parameter among the predetermined parameters, setting, as set game contents, some or all of the owned game content that have not been extracted, and matching a predetermined parameter of each of the set game contents with the lowest predetermined parameter of the reference game content, wherein in response to the player acquiring a cost for increasing a predetermined parameter of a growing game content to be grown by the player, with the reference game content as the growing game content, the information processing device is further execute automatically consuming the cost and increasing the predetermined parameter of the growing game content.

Moreover, according to a ninth aspect of the present invention, a non-transitory computer readable recording medium storing instructions that cause an information processing device causing a terminal device to execute a growing game to execute: extracting, from among game contents owned by a player, a predetermined number of game contents in descending order of predetermined parameters of the extracted game contents, identifying, as a reference game content among the extracted game contents, a game content having a lowest predetermined parameter among the predetermined parameters, setting, as set game contents, some or all of the owned game content that have not been extracted, and matching a predetermined parameter of each of the set game contents with the lowest predetermined parameter of the reference game content, wherein in response to the player acquiring a cost for increasing a predetermined parameter of a growing game content to be grown by the player, with the reference game content as the growing game content, the information processing device is further execute asking the player whether to consume the cost and increasing the predetermined parameter of the growing game content.

Furthermore, according to one or more embodiments of the present invention, it becomes possible to automatically update a growth reference of game contents in accordance with variation of parameters of the game contents in real time.

### BRIEF DESCRIPTION OF DRAWINGS

FIG. 1 is a block diagram illustrating an example of the overall configuration of the game system according to one or more embodiments.

FIG. 2 is a diagram schematically illustrating an example of a hardware configuration of a server device.

FIG. 3 is a diagram illustrating an example of a hardware configuration of a smartphone as the terminal device illustrated in FIG. 1.

FIG. 4 is a block diagram schematically illustrating an example of a functional unit of a server device.

FIG. 5 is a diagram illustrating an example of a setting screen for setting a set character.

FIG. 6 is a flowchart illustrating an example (specific example 1) of a process flow for growing a growing character (reference character) in a game system according to one or more embodiments.

FIG. 7 is a diagram illustrating an example (specific example 1) of a results screen indicating growth results of the growing character.

FIG. 8 is a flowchart illustrating an example (specific example 2) of a process flow for growing a growing character (reference character) in a game system according to one or more embodiments.

FIG. 9 is a diagram illustrating an example of a confirmation screen to inquire of growth of the growing character.

FIG. 10 is a diagram illustrating an example (specific example 2) of a results screen indicating growth results of the growing character.

### DETAILED DESCRIPTION OF EMBODIMENTS

Embodiments of the present invention will be described hereinafter with reference to accompanying drawings. In order to facilitate understanding of the description, the same constituent elements and steps are denoted by the same reference numerals as much as possible in each drawing, and duplicate descriptions are omitted.

### <Overall Configuration>

FIG. 1 is a block diagram illustrating an example of the overall configuration of the game system 1 according to one or more embodiments.

As illustrated in FIG. 1, the game system 1 includes a server device 10 and one or more terminal devices 12. The server device 10 and the terminal device 12 are connected via a communication network NT such as an intranet, the Internet, or a telephone line so as to be capable of communication.

The server device 10 is an information processing device that provides the results of the game executed by executing instructions such as a game program 14, or the instructions themselves, to a player of each terminal device 12 via a communications network NT. In one or more embodiments, the server device 10 provides the instructions themselves to the player of the terminal device 12.

Each terminal device 12 is an information processing device owned by each player, and after the instructions received from the server device 10 is installed, this is executed to provide each player with a game. Examples of these terminal devices 12 include video game machines, arcade game machines, mobile phones, smartphones, tablets, personal computers, and the like.

### <Hardware Configuration>

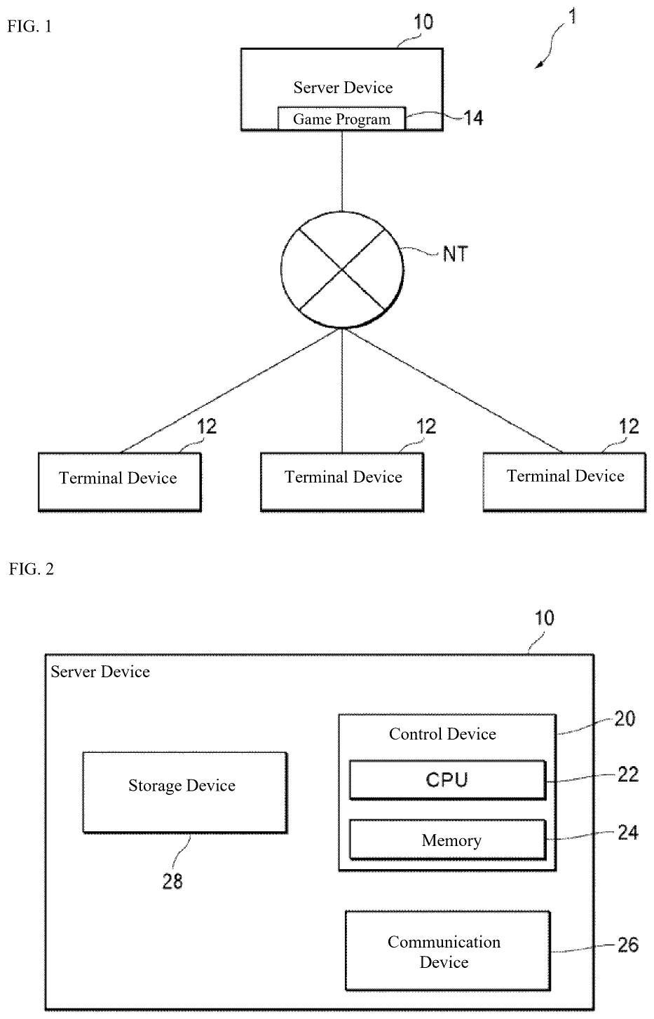

FIG. 2 illustrates a schematic diagram of an example of the hardware configuration of the server device 10.

As illustrated in FIG. 2, the server device 10 includes a control device (or hardware processor) 20, a communication device (or communication interface) 26, and a storage device (or storage) 28. The control device 20 is mainly composed of a CPU (Central Processing Unit) 22 and a memory 24.

In the control device 20, the CPU 22 executes predetermined instructions stored in the memory 24, the storage device 28, or the like, thereby functioning as various functional units. The details of this function will be described later.

The communication device 26 is composed of a communication interface or the like for communicating with an external device. The communication device 26 transmits and receives various types of information to and from the terminal device 12, for example.

The storage device 28 is configured with a hard disk or the like. This storage device 28 stores various instructions and information necessary for executing processes in the control device 20, including the game program 14, as well as information on the results of the processes.

The server device 10 can be realized using an information processing device such as a dedicated or general-purpose server computer. Furthermore, the server device 10 may be configured from a single information processing device, or may be configured from a plurality of information processing devices distributed over the communications network NT. Also, FIG. 2 illustrates only a portion of the main hardware configuration of the server device 10, and the server device 10 may include other configurations that are generally included in servers. Furthermore, the hardware configuration of the plurality of terminal devices 12 may also be similar to that of the server device 10, except that they include, for example, an operating device, a display device, and a sound output device.

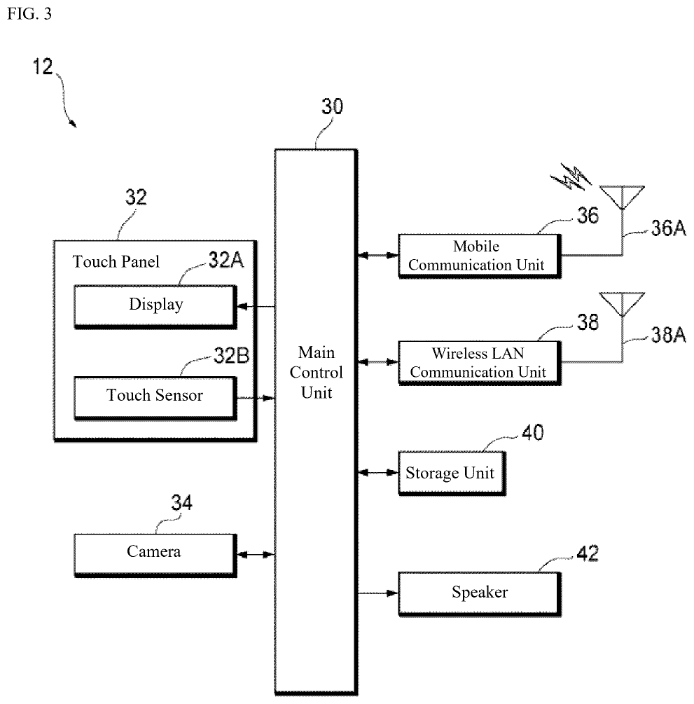

FIG. 3 illustrates an example of the hardware configuration of a smartphone as a terminal device 12 illustrated in FIG. 1.

As illustrated in FIG. 3, the terminal device 12 includes a main control unit (or hardware processor) 30, a touch panel (touch screen) 32, a camera 34, a mobile communication unit (or mobile communication interface) 36, a wireless LAN communication unit (or wireless LAN communication interface) 38, a storage unit (or storage) 40, and a speaker 42.

The main control unit 30 includes a CPU, a memory, and the like. The main control unit 30 is connected to a touch panel 32 serving as a display input device, a camera 34, a mobile communication unit 36, a wireless LAN communication unit 38, a storage unit 40, and a speaker 42. The main control unit 30 has a function of controlling these connection destinations.

The touch panel 32 has both a display function and an input function, and is composed of a display 32A that performs the display function and a touch sensor 32B that performs the input function. In one or more embodiments, the display 32A is capable of displaying game images including operation input images such as button images, cross key images, and joystick images. The touch sensor 32B is capable of detecting an input position of the player relative to the game image.

The camera 34 has a function of taking still images and/or moving images and storing them in the storage unit 40.

The mobile communication unit 36 is connected to a mobile communication network via an antenna 36A and has a function of communicating with other communication devices connected to the mobile communication network.

The wireless LAN communication unit 38 has a function of connecting to the communication network NT via an antenna 38A and communicating with other devices such as the server device 10 connected to the communication network NT.

The storage unit 40 stores various instructions and data such as the game program 14 and play data indicating the progress of the game and player information. Furthermore, the play data may be stored in the server device 10.

The speaker 42 has a function of outputting game sounds and the like.

### <Game Overview>

The game according to one or more embodiments includes a lottery game or quest in which a character can be acquired as an example of a content or a game content, a growing game in which the content (character or game character) is grown, and the like. This lottery game is sometimes called gacha, raffle, summon, or the like. This quest may also be called a fighting game, a dungeon, an exploration, a mission, or the like.

The lottery game according to one or more embodiments is a game in which, upon an execution request (instruction) from the player to play the lottery game, the player is provided with one or more characters (game contents) selected by lottery (randomly selected) from a group of lottery-subject characters (lottery-subject game content group) that are the subject of the lottery. This lottery game is executed based on the consumption of game currency owned by the player.

This game currency includes, for example, paid currency and free currency. Paid currency is paid content that is given to a player based on payment of money, prepaid cards, credit cards, electronic money, crypto assets, or the like. Examples of paid currency include charged items (paid items), charged coins (paid coins), charged points (paid points), or the like. For example, in the game of one or more embodiments, one charged item can be purchased for 150 yen. Conversely, free currency is free content that is given to a player by playing a game. Examples of free currency include non-charged items (free items), non-charged coins (free coins), and non-charged points (free points). This game execution includes the player logging into the game, completing a quest, or the like. Free currency can be consumed in various games without distinction from paid currency. For example, in a certain lottery game, charged items and non-charged items can be consumed without distinction. Furthermore, in another lottery game, only charged items may be consumed.

In addition, a quest in one or more embodiments is a game in which a deck (party) made up of characters owned by the player is pitted against enemy characters (including boss characters) that appear, based on instructions (requests) from the player to carry out a specified quest.

For example, a player can organize a deck to be used in a quest by, as desired, selecting a predetermined number (for example, five) or less of characters from the owned characters in an organization menu for organizing a deck to be used in a quest in advance. When a player clears a quest, the player can receive a clear reward. Examples of clearing a quest include, for example, defeating all enemy characters that appear in the quest (reducing their hit points to zero or less) or defeating the boss character that appears at the end of the quest.

The growing game of one or more embodiments is a game in which a character designated by a player from among owned characters (owned content) is made to be the growing character, and this growing character (growing content) is then strengthened or evolved by consuming the player's own costs (material content). This cost (material content) includes characters (material characters), material items (strengthening items), coins, game currency, and the like. Furthermore, this cost can also be earned through rewards for completing quests, login bonuses for the game, purchases at in-game shops, or the like.

In the growing game of one or more embodiments, a first character synthesis is performed in which a predetermined cost is consumed for each predetermined parameter (for example, level) of the growing character, thereby performing strengthening synthesis for increasing (changing) the predetermined parameter of the growing character. Examples of the pre-associated costs include material items, coins, and the like.

For example, the player can specify one character from a list of owned characters on a character strengthening menu to make that one character a growing character (character to be strengthened). By designating this growing character, the player can make a request (strengthening instruction) to increase a predetermined parameter of the growing character on a growth screen including an image showing the growing character.

In addition, in the growing game according to one or more embodiments, as a second character synthesis, an evolutionary synthesis is performed in which the growing character evolves by consuming the cost that has been previously associated with the growing character. Examples of the pre-associated cost include a character with the same name as the character being growing character (same type of character), a character with the same attributes as the growing character, or the like. Examples of the evolution of a growing character include an increase in the rarity of the growing character and an increase in the upper limit of a predetermined parameter (for example, level) of the growing character.

For example, the player can specify one character from among the owned characters on a character evolving menu to make that one character a growing character (character to evolve). The player can specify the growing character and issue a request to evolve the growing character (an evolution instruction).

In addition, in the growing game of one or more embodiments, the predetermined parameters of the set character (setting content) described below automatically match (link) with the predetermined parameters of the reference character (reference content) described below, and thus the set character cannot be designated as a growing character (strengthened character). That is, the player cannot designate a set character from among the list of predetermined characters as a growing character (strengthened character) on the character strengthening menu.

For example, when a player wishes to increase a predetermined parameter of a set character, the player must increase the predetermined parameter of a reference character, or cancel the setting of the set character on the setting screen and then designate the set character as a growing character (strengthened character).

### <Functional Units> (Specific Example 1)

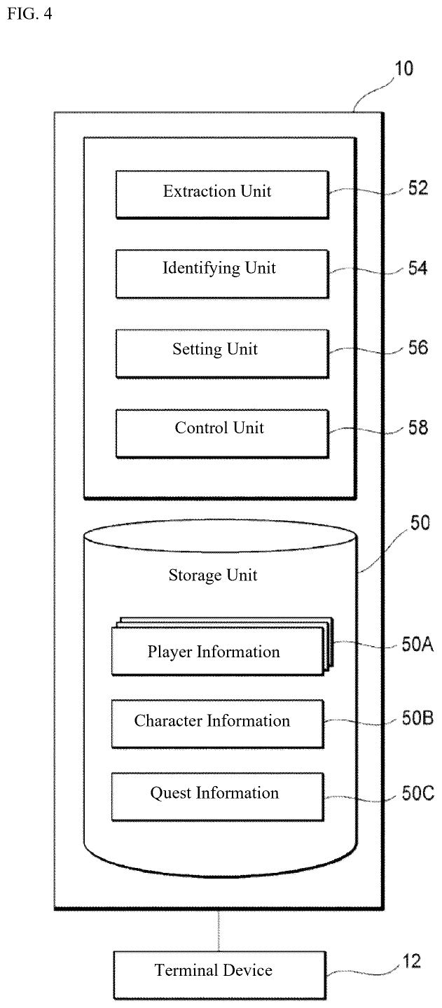

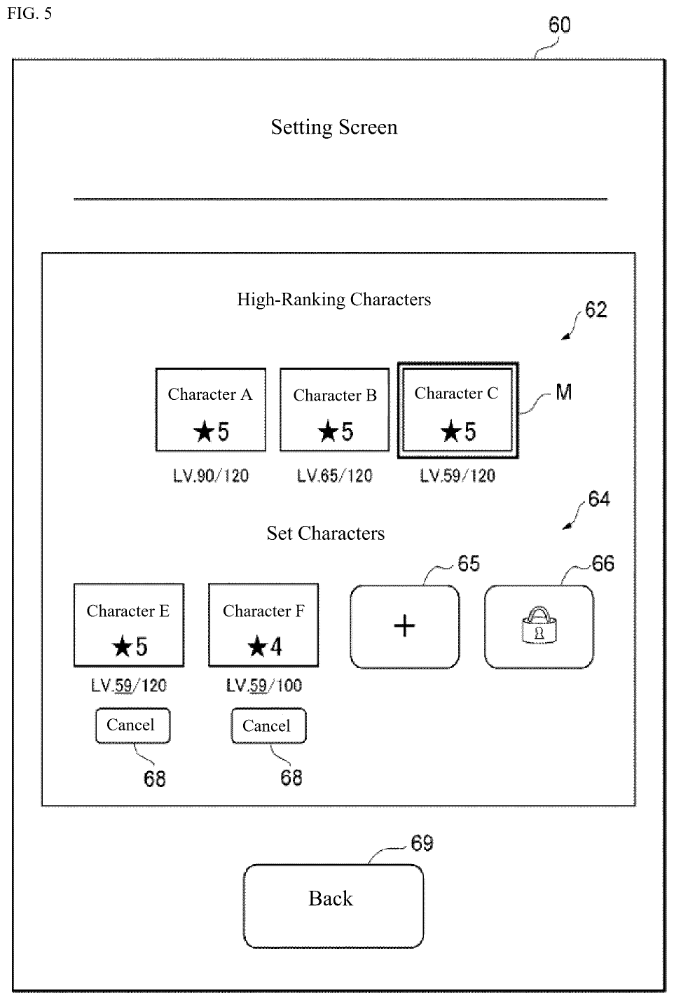

FIG. 4 is a block diagram schematically illustrating an example of the functional units of the server device 10.

As illustrated in FIG. 4, the server device 10 includes, as functional components, a storage unit 50, an extraction unit 52, a identifying unit 54, a setting unit 56, and a control unit 58. The storage unit 50 are realized by one or more storage devices 28. The functional units other than the storage unit 50 are realized by the control device 20 executing the instructions stored in the storage device 28 or the like. Furthermore, some or all of these functional configurations may be provided in the terminal device 12.

The storage unit 50 has a function of storing player information 50A, character information 50B, quest information 50C, and the like.

The player information 50A is stored for each player in association with the player ID of the player. The player information 50A may include, for example, the player's name, age, player rank, owned content information, reference character information, set character information, number of settings possible, or the like.

The player rank increases, for example, when the player acquires player experience points.

The owned content information includes owned character information, owned item information, and the like.

The owned character information is stored for each owned character owned by the player in association with an owned character ID. This character ID is, for example, allocated each time a player acquires (owns) a character. For example, the more recently a character is acquired by a player, the higher the value of the owned character ID. Also, for example, even the owned character IDs of characters of the same type each include different numerical values. The owned character information includes, for example, the character's character ID and ability parameters. Examples of ability parameters include level, hit points, attack power, defense power, and the like. In one or more embodiments, for example, when a character's level increases through a growing game, the character's hit points, attack power, defense power, and the like increase.

The owned item information includes item IDs and quantities of various items owned by the player. Examples of such items include game currency (for example, charged items and non-charged items), material items, coins, weapon items, armor items, and the like.

The reference character information includes the character ID owned by the reference character, a target value, and an automatic growth flag. This reference character is, for example, a character whose predetermined parameter (for example, level) is in a predetermined ranking (for example, third) from the top among the owned characters. The target value includes a predetermined value as a target of the predetermined parameter. Examples of the predetermined value may be a value designated by the player, a recommended value of a predetermined parameter corresponding to a predetermined quest, a value determined in advance by the game operator, an upper limit of a predetermined parameter, or the like. Examples of these predetermined quests include quests that the player has not yet completed, quests in which powerful boss characters appear, and the like. The recommended value here is, for example, a predetermined parameter recommended for completing a predetermined quest. The automatic growth flag is a flag that indicates whether the reference character is to be automatically grown. This flag can be changed (ON/OFF) by, for example, an instruction from the player. Furthermore, this flag is changed to OFF when a predetermined parameter of the reference character reaches a target value (predetermined value).

The set character information includes the character ID owned by each set character, and the predetermined parameters (for example, level) of each set character before setting. The set character is, for example, one or more characters that are set (selected) in advance by the player from among the characters owned by the player.

The number that can be set includes the number of characters (upper limit) that the player can set as a set character. This number that can be set increases, for example, as the player's rank increases or as the player spends game currency.

Character information 50B is stored for each character in association with the character ID of that character. The character information 50B includes, for example, the character's name and image (character image or icon image), ability information, required cost, rarity, and the like. This character information 50B is updated as the game operator updates the game.

Ability information includes initial values and upper limits of ability parameters (level, hit points, or the like), skills, or the like. Skills include abilities to recover hit points for friendly characters in a quest or to inflict large damage on enemy characters.

The required cost includes the type and quantity of material content required to increase a predetermined parameter (for example, level) of a character. This required cost is determined in advance for each predetermined parameter (level), for example. For example, the cost required for a character to reach a predetermined parameter (level) to acquire a skill is set to have a larger variety and quantity of material content than usual.

Rarity includes numbers ranging from 1 to 6, for example. This number may be indicated, for example, by a number of stars. In this case, characters with high rarity are set with advantageous ability parameters (for example, upper level limit) and skills or the like in the game (for example, quests).

Quest information 50C is stored for each quest in association with the quest ID of the quest. The quest information 50C includes the name and difficulty of the quest, enemy character information, reward information for completion, and the like.

The difficulty level includes numbers from 1 to 6, for example. The difficulty level, for example, indicates that the higher the number, the more difficult it is to complete.

The enemy character information includes the character ID and ability parameters of each enemy character that appears in the quest.

The completion reward information includes a completion reward that can be acquired when the quest is completed. Examples of this completion reward include game currency (non-charged items), characters (material characters), material items, player experience points, weapon items, armor items, and the like. For example, the more difficult the quest, the greater the reward for clearing it.

The extraction unit 52 is a functional unit for extracting a predetermined number of characters. In one or more embodiments, the extraction unit 52 extracts a predetermined number of characters from among the characters owned by the player in descending order of a predetermined parameter (for example, level). An example of this predetermined number is three. In other words, the extraction unit 52 extracts, from among the owned characters, characters whose predetermined parameters are ranked from the top to a predetermined rank (for example, third) as high-ranking characters (high-ranking content). For example, when extracting a predetermined number of characters, when there are multiple characters with the same predetermined parameters, the extraction unit 52 will preferentially extract from among the multiple characters the character with the highest numerical value contained in its owned character ID (the character with the latest acquisition date and time).

The extraction unit 52 extracts a predetermined number of characters (high-ranking characters) at a predetermined timing. Examples of the predetermined timing include the timing at which a predetermined parameter (for example, level) of an owned character changes, the timing at which the player acquires (owns) a character, the timing at which an owned character is sold (released), and the timing at which an owned character is consumed as a material character.

Furthermore, when the predetermined parameter, prior to being set, of a character that has already been set as a set character are ranked in a predetermined order from the top, the extraction unit 52 may cancel the setting of the set character using the setting unit 56 and extract the character.

The designating unit 54 is a functional unit for specifying, from among the predetermined number of characters extracted by the extracting unit 52 (high-ranking characters), a character as the reference character. In one or more embodiments, the designating unit 54 specifies, from among the predetermined number of characters (high-ranking characters) extracted by the extracting unit 52, the character having the lowest predetermined parameter (for example, level) as the reference character. For example, when there are multiple characters with the lowest predetermined parameters among the extracted predetermined number of characters, the identification unit 54 identifies, from among the plurality of characters, the character with the highest numerical value contained in the owned character ID (the character with the latest acquisition date and time) as the reference character. Next, the identifying unit 54 stores the owned character ID of the identified reference character in the reference character information of the player information 50A.

In other words, the identifying unit 54 specifies, as the reference character, a character whose predetermined parameter is ranked in a predetermined order (for example, third) from the top among the characters owned by the player.

The setting unit 56 is a functional unit for setting a character as a set character. In one or more embodiments, the setting unit 56 sets some or all of the owned characters not extracted by the extraction unit 52 as set characters. For example, the setting unit 56 sets, on the setting screen, one or more characters selected by the player from among the owned characters not extracted by the extraction unit 52, as set characters. That is, the setting unit 56 sets one or more characters selected by the player from the owned characters not including the high-ranking character extracted by the extraction unit 52, as set characters. Next, the setting unit 56 stores the owned character ID of the set character in the set character information of the player information 50A.

Furthermore, the setting unit 56 cancels the setting of a set character in response to an instruction from the player to cancel the setting of the set character on the setting screen (for example, pressing a setting cancel button). For example, the setting unit 56 refers to the set character information in the player information 50A and returns (for example, lowers) a predetermined parameter of the set character to the predetermined parameter before the setting. Next, the setting unit 56 deletes the information of the character whose setting has been cancelled from the set character information of the player information 50A.

FIG. 5 illustrates an example of a setting screen 60 for a set character. For example, the setting screen 60 is displayed when a character setting menu is selected by the player.

As illustrated in FIG. 5, the setting screen 60 is provided with a high-ranking character information area 62, a set character information area 64, a set character add button 65, a possible set number add button 66, a setting cancel button 68, and a back button 69.

The high-ranking character information area 62 displays images of characters (high-ranking characters) owned by the player that have the highest (first to third) predetermined parameters (levels), including the reference character, as well as the predetermined parameters (levels) of each of the high-ranking characters. Moreover, a mark M is attached to the reference character.

The set character information area 64 displays an image of a character that the player has set as a set character from among the characters owned by the player, predetermined parameters of the set character that are made to match those of a reference character, and the like. The predetermined parameters before setting each set character may be represented in the set character information area 64.

The set character add button 65 is a button for issuing an instruction to add a new set character from among the characters owned by the player, excluding high-ranking characters.

The possible set number add button 66 is a button used to give an instruction to add one possible set number of set characters. This addition may require, for example, the consumption of game currency.

The setting cancel button 68 is a button used to give an instruction to cancel the respective settings of the corresponding set characters. For example, when the player presses the setting cancel button 68, an image showing the corresponding set characters is changed to the set character add button 65.

The back button 69 is a button used to give an instruction to return (transition) to the main menu screen.

Returning to FIG. 4, the control unit 58 is a functional unit for controlling the entire game. In one or more embodiments, the control unit 58 causes the predetermined parameters of each set character to match the predetermined parameters of a reference character. Hereinafter, the predetermined parameters of the reference character will be referred to as reference parameters or reference levels. For example, the control unit 58 refers to the owned character information, set character information, and reference character information in the player information 50A, and matches (links) a predetermined parameter (for example, level) of one or more set characters with a predetermined parameter (for example, level) of the reference character. Here, when the control unit 58 matches the predetermined parameters of the set character with the predetermined parameters of the reference character, it does not consume the cost associated with the player (owned by the player). In other words, the control unit 58 automatically matches the predetermined parameters of each set character with the predetermined parameters of the reference character.

Furthermore, the control unit 58 automatically increases a predetermined parameter of the growing character (growing content). In one or more embodiments, when the player acquires the cost (material content) for increasing a predetermined parameter (level) of the growing character with the reference character as the growing character, the control unit 58 automatically consumes the cost to increase a predetermined parameter (level) of the growing character.

For example, when a player acquires cost, the control unit 58 refers to the player information 50A and the character information 50B to determine whether the player has the cost necessary to increase a predetermined parameter (level) of the reference character in the content owned by the player. Then, when the determination is positive, the control unit 58 automatically consumes the cost owned by the player to increase a predetermined parameter (level) of the reference character.

For example, the control unit 58 consumes the maximum amount of the cost from the content owned by the player to increase a predetermined parameter (level) of the reference character as much as possible. Note that the control unit 58 may allow a predetermined parameter (level) of the reference character to increase to exceed a predetermined parameter (level) of another high-ranking character, and limit further increases. That is, the control unit 58 may increase a predetermined parameter of the reference character until the reference character is changed to another high-ranking character.

Furthermore, the control unit 58 automatically consumes the cost until a predetermined parameter of the growing character (reference character) reaches a predetermined value. For example, the control unit 58 refers to a target value of the reference character information in the player information 50A and automatically consumes the cost to increase a predetermined parameter of the reference character until the predetermined parameter reaches a predetermined value, that is, the target value.

Moreover, the control unit 58 changes the growing character to another character every time the reference character is changed to this other character. For example, by a predetermined parameter of the reference character being increased, the control unit 58 changes another high-ranking character to the growing character when this high-ranking character is changed to the reference character.

Furthermore, the control unit 58 manages the settable number of the player information 50A. For example, the control unit 58 increases (raises) the settable number due to a player's rank increasing or the player consuming game currency.

### <Development Process Flow>

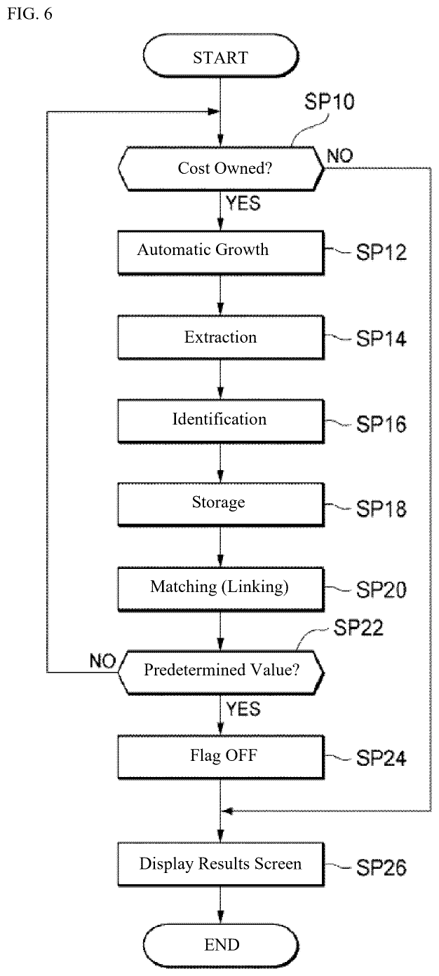

FIG. 6 is a flowchart illustrating an example (specific example 1) of a process flow for developing a growing character (reference character) in a game system according to one or more embodiments. Furthermore, the processing of the following steps is initiated, for example, when the automatic growth flag is ON and the player acquires (owns) a cost (material content). The order and content of the following steps may be changed as appropriate.

### (Step SP10)

The control unit 58 sets the reference character stored in the reference character information of the player information 50A as the growing character. That is, the control unit 58 changes the growing character to another character every time the reference character is changed to this other character. Then, the control unit 58 refers to the player information 50A and the character information 50B to determine whether the player owns the cost necessary to increase a predetermined parameter (level) of the growing character by one. If the determination is positive, the process moves to step SP12. Conversely, if the determination is negative, the process moves to step SP26.

### (Step SP12)

The control unit 58 then carries out automatic growth to automatically consume the cost owned by the player to increase a predetermined parameter (level) of the growing character (reference character) by one. The process then moves to step SP14.

### (Step SP14)

The extraction unit 52 refers to the owned character information in the player information 50A, and extracts a predetermined number (for example, three) of characters from among the owned characters in descending order of a predetermined parameter (for example, level). For example, the extraction unit 52 extracts character A whose predetermined parameter is 90, character B whose predetermined parameter is 65, and character C whose predetermined parameter is 60 from the owned characters. Then, the process proceeds to step SP16.

### (Step SP16)

The identification unit 54 defines, as a reference character, the character having the lowest predetermined parameter (for example, level) from among the predetermined number of characters extracted in step SP14. For example, the identification unit 54 identifies character C, whose predetermined parameter is 60, as the reference character. The process then moves to step SP18.

### (Step SP18)

The identifying unit 54 stores the character ID owned by the reference character (character C) identified in step SP16 in the reference character information in the player information 50A. The process then moves to step SP20.

### (Step SP20)

The control unit 58 refers to the owned character information of the player information 50A, the set character information, and the reference character information to match (link) the predetermined parameters (for example, level) of each of the set characters to the reference parameter. For example, the control unit 58 stores the predetermined parameters of each set character in the owned character information of the player information 50A as the predetermined parameters (reference parameters) 60 of a reference character (character C). The process then moves to step SP22.

### (Step SP22)

The control unit 58 determines whether a predetermined parameter (reference parameter) of the growing character (reference character) has reached a predetermined value. If the determination is positive, the process moves to step SP24. Conversely, when the determination is negative, the process moves to step SP10.

### (Step SP24)

The control unit 58 changes the automatic growth flag of the reference character information in the player information 50A to OFF. The process then moves to step SP26.

### (Step SP26)

The control unit 58 causes the touch panel 32 to display a results screen including an image showing growth results of the growing character (reference character). Note that the control unit 58 may not display the results screen when the player does own cost sufficient to increase the predetermined parameter of the growing character (reference character) by one.

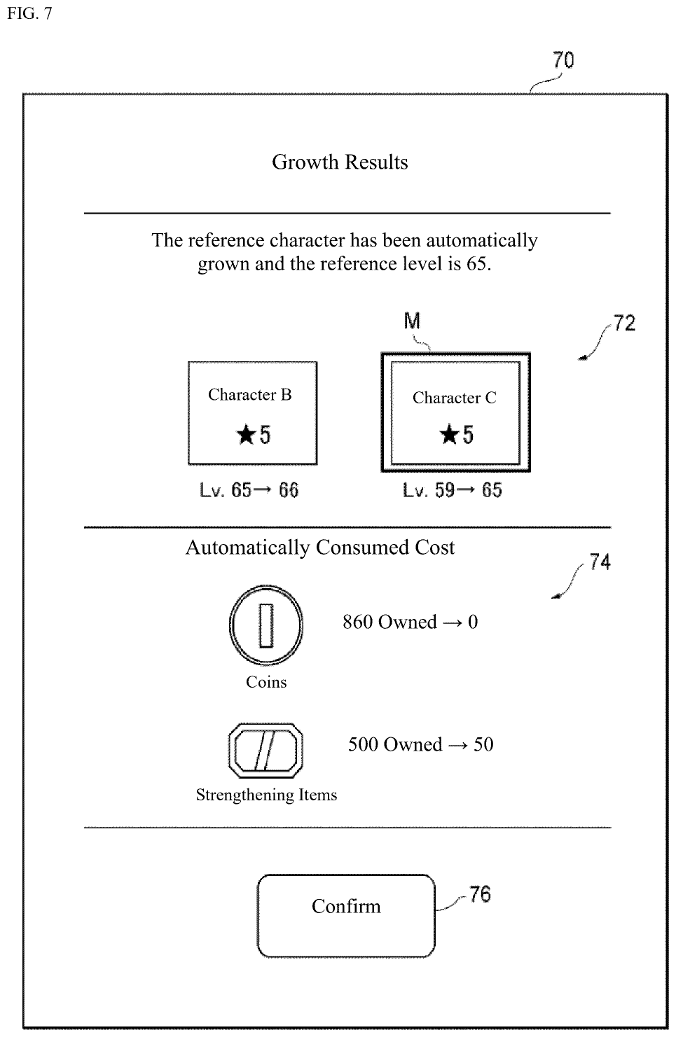

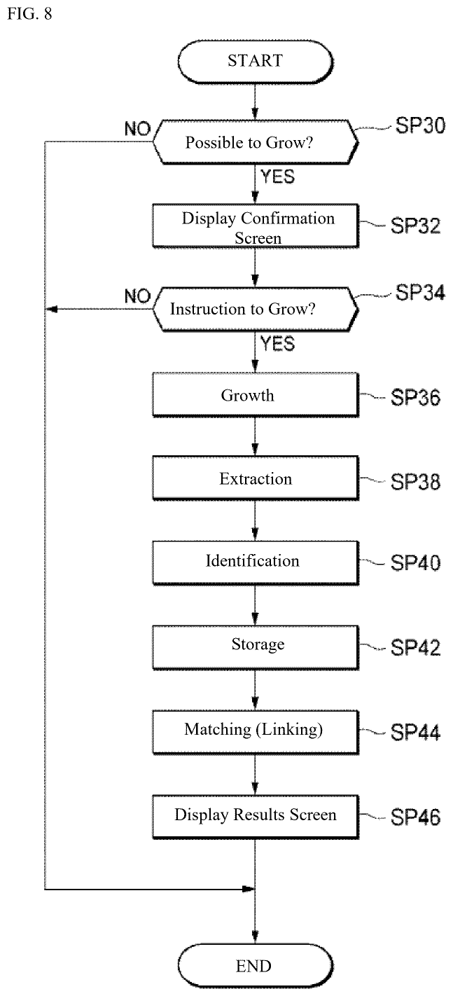

FIG. 7 is a diagram illustrating an example (specific example 1) of a results screen 70 indicating growth results of a growing character.

As illustrated in FIG. 7, the results screen 70 is provided with a growing character information area 72, a consumption cost information area 74, and a confirmation button 76.

The growing character information area 72 displays that the reference parameter (reference level) has increased (has undergone automatic growth), a character image showing the owned characters that have been automatically grown, a predetermined parameter (level) before and after growth, and the like. The character image is marked with the mark M indicating, for example, that such is the current reference character.

In the consumption cost information area 74, it is indicated that the costs (material contents) owned by the player have been automatically consumed.

The confirmation button 76 is a button used to give an instruction to close the results screen and transition to the main menu screen.

Then, the series of processes illustrated in FIG. 6 is ended.

### Specific Example 2

In specific example 1 described above, a description was given wherein in step SP12, the control unit 58 automatically grows the growing character (reference character), but it is also possible to carry out growing after asking the player whether to grow the growing character.

For example, when the player acquires the cost for increasing a predetermined parameter of a growing character with the reference character (reference content) as the growing character (growing content), the control unit 58 asks the player whether to consume the cost and increase the predetermined parameter of the growing character. Next, when a growth instruction is received from the player, the control unit 58 increases a predetermined parameter of the growing character.

### <Growing Process Flow>

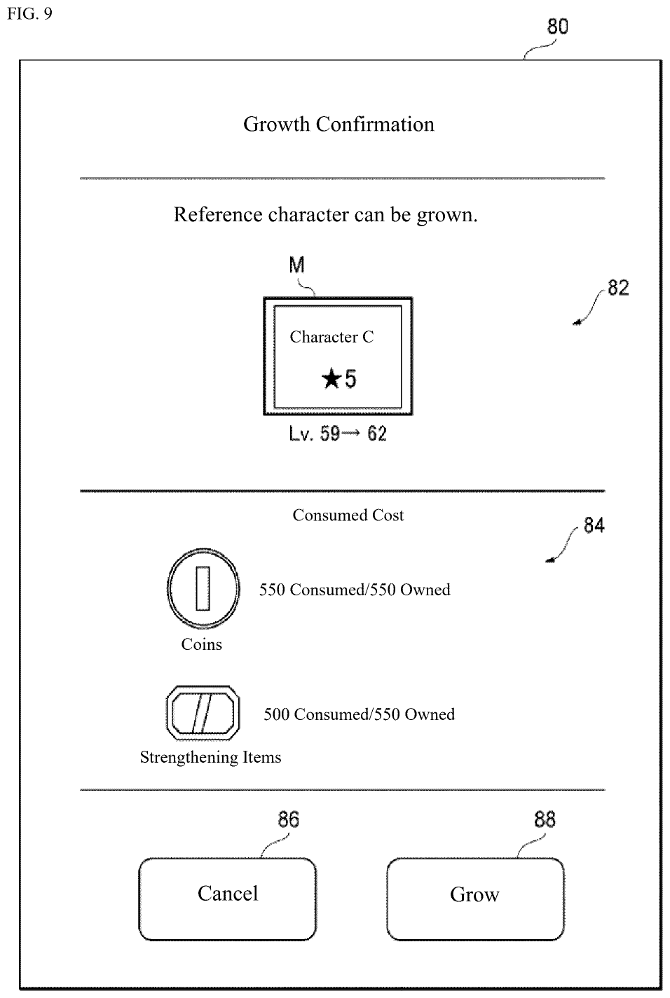

FIG. 8 is a flowchart illustrating an example (specific example 2) of a process flow for growing a growing character (reference character) in a game system according to one or more embodiments. Furthermore, the processing of the following steps is initiated at the timing when the player acquires (owns) a cost (material content). The order and content of the following steps may be changed as appropriate.

### (Step SP30)

The control unit 58 sets the reference character stored in the reference character information of the player information 50A as the growing character. Then, the control unit 58 refers to the player information 50A and the character information 50B, and calculate a numerical value (maximum value) that makes it possible to consume the cost owned by the player to increase the predetermined parameter (level) of the growing character. Next, the control unit 58 determines whether the calculated numerical value is 1 or greater. If the determination is positive, the process moves to step SP32. Conversely, when the determination is negative, the series of processes illustrated in FIG. 8 is ended.

### (Step SP32)

The control unit 58 causes the touch panel 32 to display a confirmation screen to ask whether to grow the growing character (reference character).

FIG. 9 is a diagram illustrating an example of a confirmation screen 80 to inquire of growth of a growing character.

As illustrated in FIG. 9, the confirmation screen 80 is provided with a growing character information area 82, a consumed cost information area 84, a cancel button 86, and a grow button 88.

The growing character information area 82 shows a character image showing the growing character (reference character), a predetermined parameter (level) when grown to the current predetermined parameter (level), and the like.

The consumption cost information area 84 shows the cost consumed for growing (material content) and the cost owned by the player.

The cancel button 86 is a button used to give an instruction to transfer to the main menu screen without carrying out growing.

The grow button 88 is a button used to give an instruction to grow the growing character.

Returning to FIG. 8, the process moves to step SP34.

### (Step SP34)

The control unit 58 determines whether a growth instruction has been given by the player. For example, the control unit 58 determines whether the grow button 88 is pressed on the confirmation screen. If the determination is positive, the process moves to step SP36. Conversely, if the determination is negative, that is, when the cancel button is pressed, the series of processes illustrated in FIG. 8 is ended.

### (Step SP36)

The control unit 58 then carries out growing to consume the cost owned by the player to increase a predetermined parameter (level) of the growing character (reference character). For example, the control unit 58 increases a predetermined parameter (level) of the growing character (reference character) to the numerical value (maximum value) calculated in step SP30. Then, the process proceeds to step SP38.

### (Step SP38 to Step SP44)

The process in step SP38 to step SP44 is similar to the process in step SP14 to step SP20 described above, and therefore the description thereof will be omitted. The process then moves to step SP46.

### (Step SP46)

The control unit 58 causes the touch panel 32 to display a results screen including an image showing growth results of the growing character (reference character).

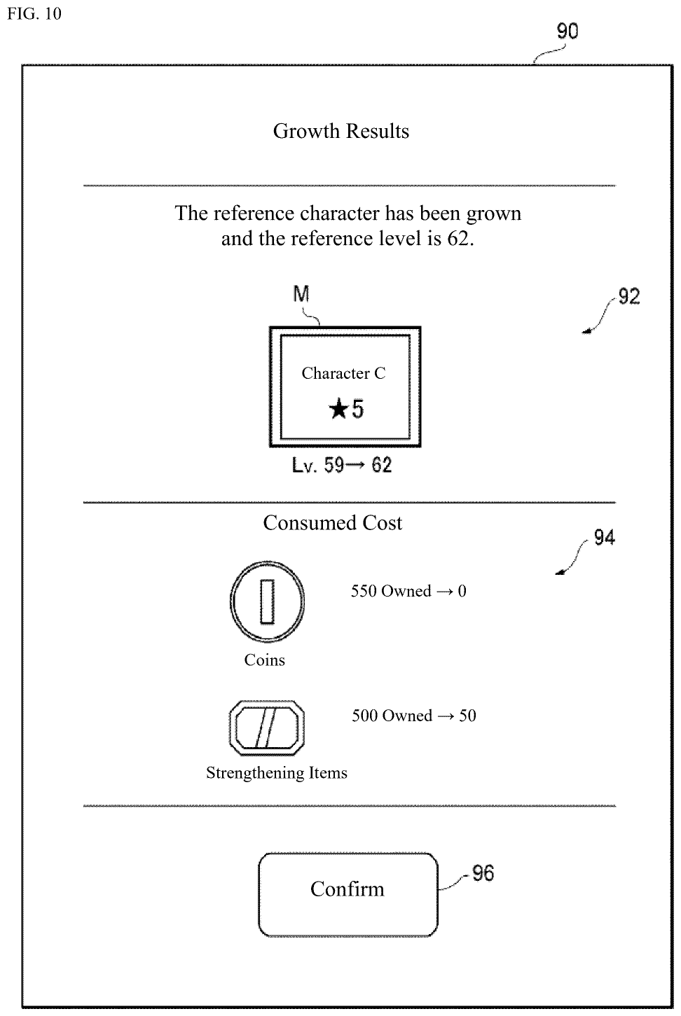

FIG. 10 is a diagram illustrating an example (specific example 2) of a results screen 90 indicating growth results of a growing character.

As illustrated in FIG. 10, the results screen 90 is provided with a growing character information area 92, a consumption cost information area 94, and a confirmation button 98.

The growing character information area 92 displays that the reference parameter (reference level) has increased, a character image showing the reference characters that have been grown, a predetermined parameter (level) before and after growth, and the like.

In the consumption cost information area 94, it is indicated that the costs (material contents) owned by the player have been consumed.

Then, the series of processes illustrated in FIG. 8 is ended.

### Technical Improvements

Above, in the one or more embodiments, a computer is made to function as the extracting unit 52 that extracts, from among content owned by a player, a predetermined number of content in descending order of a predetermined parameter, the identifying unit 54 that identifies, from the extracted content, the content having the lowest predetermined parameter as reference content, the setting unit 56 that sets, as set content, some or all of the owned content not extracted, and the control unit 58 that matches a predetermined parameter of each of the set content with a predetermined parameter of the reference content, wherein when the player acquires a cost for increasing a predetermined parameter for a growing content to be grown by the player, with the reference content as the growing content, the control unit 58 automatically consumes the cost and increases the predetermined parameter of the growing content.

This configuration enables automatically updating the growth reference of the game contents in accordance with variation of the parameters of the game contents in real time. For example, according to this configuration, the cost acquired by the player is automatically consumed, and the predetermined parameter of the reference content can be increased. As a result, the effort and time required to grow the character can be reduced.

Furthermore, in one or more embodiments, the control unit 58 changes the growing content to other content every time the reference content is changed to the other content.

According to this configuration, the growing target for which the cost has been automatically consumed is changed to other content every time the reference content is changed to the other content. As a result, the time and effort required to grow the reference content can be reduced.

Moreover, in one or more embodiments, the control unit 58 automatically consumes the cost until the predetermined parameter of the growing content reaches a predetermined value.

According to this configuration, the predetermined parameter of the reference content automatically increases until it reaches a predetermined value. As a result, the time and effort required to grow the reference content can be reduced. Furthermore, the predetermined parameters of the reference content do not automatically exceed predetermined values. As a result, it is possible to suppress cost consumption.

Moreover, in one or more embodiments, the predetermined value is a value designated by the player.

According to this configuration, the predetermined parameter of the reference content automatically increases until it reaches a predetermined value based on the predetermined value designated by the player. As a result, the time and effort required to grow the reference content can be reduced. Furthermore, the predetermined parameters of the reference content do not automatically exceed predetermined values. As a result, it is possible to suppress cost consumption.

Furthermore, in one or more embodiments, the predetermined value is the recommended value of a predetermined parameter corresponding to a specific quest.

According to this configuration, the predetermined parameter automatically increases to the recommended value for the predetermined quest. As a result, the effort required to grow the reference content can be reduced. Furthermore, the predetermined parameters of the reference content do not automatically exceed predetermined values. As a result, it is possible to suppress cost consumption.

Also, in one or more embodiments, the control unit 58 does not consume a cost when matching the predetermined parameters of the set content with the predetermined parameters of the reference content.

According to this configuration, the time and effort to obtain the cost to grow the set content is reduced. As a result, the player is motivated to play the game.

Moreover, in one or more embodiments, a computer is made to function as the extracting unit 52 that extracts, from among content owned by a player, a predetermined number of content in descending order of a predetermined parameter, the identifying unit 54 that identifies, from the extracted content, the content having the lowest predetermined parameter as reference content, the setting unit 56 that sets, as set content, some or all of the owned content not extracted, and the control unit 58 that matches a predetermined parameter of each of the set content with a predetermined parameter of the reference content, wherein when the player acquires a cost for increasing a predetermined parameter for a growing content to be grown by the player, with the reference content as the growing content, the control unit 58 asks the player whether to consume the cost and increase the predetermined parameter of the growing content.

According to this configuration, when the player acquires a cost, the player is asked whether to increase the predetermined parameter of the reference content. As a result, the time and effort required to grow the reference content can be reduced.

### EXAMPLES

It should be noted that the present invention is not limited to the above specific examples. In other words, even were a person skilled in the art to make appropriate design modifications to the above specific examples, these are included within the scope of the present invention insofar as they have the characteristics of the present invention. Furthermore, the elements of the embodiments described above and the modified examples described below can be combined to the extent technically possible, and combinations of these are also included within the scope of the present invention insofar as they include the features of the present invention.

For example, in one or more embodiments, the control unit 58 is described as matching the predetermined parameters of each set character with the predetermined parameters of the reference character when the predetermined parameters of the growing character (reference character) increase, but the present invention is not limited to this. For example, the timing for matching the predetermined parameters may be at regular intervals, when the player logs in, before the setting screen or the like is displayed, before a quest is performed, when the player acquires (owns) a character, when an owned character is sold (released), when an owned character is consumed as a material character (material content), and the like.

Furthermore, in one or more embodiments, the growing game has been described as a case in which a predetermined cost (material content) is consumed for each of the predetermined parameters of the growing character as the first character synthesis, but the first character synthesis may also consume a cost (material content) selected by the player as desired. For example, in the first character synthesis, the player may select, as desired, a growing character from among the owned characters and a cost (material content) to be consumed, and combine these to strengthen the growing character. In this case, the cost (material content) consumed in automatic growth include characters and material items whose rarity is at or below a certain value.

Furthermore, in one or more embodiments, the control unit 58 is described as increasing a predetermined parameter of a growing character (reference character), but such may decrease the predetermined parameter. For example, in a case where the lower the value of a predetermined parameter, the more advantageously the game can be played, the control unit 58 may decrease the predetermined parameter by consuming the cost. Examples of the predetermined parameters include the number of turns required to activate a skill, the cost value required to organize owned characters into a deck (party), and the like. In this case, the reference character may be a player-owned character with a predetermined rank from the bottom (for example, third) in terms of a predetermined parameter.

Furthermore, in one or more embodiments, a description was given wherein the control unit 58 does not consume the cost (material content) associated with the player when matching the predetermined parameters of the set character with the predetermined parameters of the reference character, but the cost may be consumed. This cost may also be over time.

In addition, in one or more embodiments, a description was given wherein the control unit 58 grows a reference character as a growing character, but some or all of the high-ranking characters may be grown as growing characters. For example, the control unit 58 determines some or all of the high-ranking characters as a growing character via a request to the player.

Furthermore, in one or more embodiments, the set characters are described as being, for example, one or more characters that are pre-set (selected) by the player from among the characters owned by the player, but the set characters may be automatically set regardless of the player's selection. For example, the setting unit 56 may automatically set a predetermined number (up to a settable number) of owned characters that have not been extracted by the extraction unit 52. In this case, the setting unit 56 gives priority to characters with high rarity or characters with low predetermined parameters (levels).

Moreover, in one or more embodiments, the reference character is one character (single), but the reference character may be a plurality of characters. For example, when there are multiple characters with the lowest predetermined parameters (for example, levels) among the predetermined number of characters (higher order characters) extracted by the extraction unit 52, the identification unit 54 identifies the multiple characters as reference characters. In this case, the control unit 58 may grow (increase predetermined parameters) a plurality of reference characters collectively as growing characters.

Furthermore, in one or more embodiments, the description was given wherein the predetermined parameter is mainly a level, but the predetermined parameter may also be luck, a level limit, a skill level, rarity, hit points, attack power, defense power, or the like.

Furthermore, in one or more embodiments, a description was given wherein a character is mainly used as an example of content, but the content may be a weapon item, an armor item, a card, an avatar, a costume, or the like.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF REFERENCE NUMERALS

10 . . . server device 12 . . . terminal device 50 . . . storage unit 52 . . . extraction unit 54 . . . identification unit 56 . . . setting unit 58 . . . control unit

What is claimed is:

1. An information processing device that causes a terminal device to execute a growing game, the information processing device comprising:
a hardware processor that:
extracts, from among game contents owned by a player, a predetermined number of game contents in descending order of predetermined parameters of the extracted game contents,
identifies, as a reference game content among the extracted game contents, a game content having a lowest predetermined parameter among the predetermined parameters,
sets, as set game contents, some or all of the owned game contents that have not been extracted, and
matches a predetermined parameter of each of the set game contents with the lowest predetermined parameter of the reference game content, wherein
in response to the player acquiring a cost for increasing a predetermined parameter of a growing game content to be grown by the player, with the reference game content as the growing game content, the hardware processor automatically consumes the cost and increases the predetermined parameter of the growing game content.

2. The information processing device according to claim 1, wherein the hardware processor changes the growing game content to another game content every time the reference game content is changed to the other game content.

3. The information processing device according to claim 2, wherein the hardware processor automatically consumes the cost until the predetermined parameter of the growing game content reaches a predetermined value.

4. The information processing device according to claim 3, wherein the predetermined value is a value specified by the player.

5. The information processing device according to claim 3, wherein the predetermined value is a recommended value of a predetermined parameter corresponding to a predetermined quest.

6. The information processing device according to claim 1, wherein the hardware processor does not consume the cost when matching the predetermined parameter of each of the set game contents with the lowest predetermined parameter of the reference game content.

7. An information processing device that causes a terminal device to execute a growing game, the information processing device comprising:
a hardware processor that:
extracts, from among game contents owned by a player, a predetermined number of game contents in descending order of predetermined parameters of the extracted game contents,
identifies, as a reference game content among the extracted game contents, a game content having a lowest predetermined parameter among the predetermined parameters,
sets, as set game contents, some or all of the owned game contents that have not been extracted; and
matches a predetermined parameter of each of the set game contents with the lowest predetermined parameter of the reference game content, wherein
in response to the player acquiring a cost for increasing a predetermined parameter of a growing game content to be grown by the player, with the reference game content as the growing game content, the hardware processor asks the player whether to consume the cost and increase the predetermined parameter of the growing game content.

8. A non-transitory computer readable recording medium storing instructions that cause an information processing device causing a terminal device to execute a growing game to execute:
extracting, from among game contents owned by a player, a predetermined number of game contents in descending order of predetermined parameters of the extracted game contents;
identifying, as a reference game content among the extracted game contents, a game content having a lowest predetermined parameter among the predetermined parameters;
setting, as set game contents, some or all of the owned game content that have not been extracted; and
matching a predetermined parameter of each of the set game contents with the lowest predetermined parameter of the reference game content, wherein
in response to the player acquiring a cost for increasing a predetermined parameter of a growing game content to be grown by the player, with the reference game content as the growing game content, the information processing device is further execute automatically consuming the cost and increasing the predetermined parameter of the growing game content.

9. A non-transitory computer readable recording medium storing instructions that cause an information processing device causing a terminal device to execute a growing game to execute:
extracting, from among game contents owned by a player, a predetermined number of game contents in descending order of predetermined parameters of the extracted game contents;
identifying, as a reference game content among the extracted game contents, a game content having a lowest predetermined parameter among the predetermined parameters;
setting, as set game contents, some or all of the owned game content that have not been extracted; and
matching a predetermined parameter of each of the set game contents with the lowest predetermined parameter of the reference game content, wherein
in response to the player acquiring a cost for increasing a predetermined parameter of a growing game content to be grown by the player, with the reference game content as the growing game content, the information processing device is further execute asking the player whether to consume the cost and increasing the predetermined parameter of the growing game content.
